(19) United States
(12) Patent Application Publication
(10) Pub. No.: US 2023/0329289 A1
(43) Pub. Date: Oct. 19, 2023

(54) METHOD AND SYSTEM FOR CONDIMENT REHYDRATION

(71) Applicant: AWSM Sauce Co, West Chester, PA (US)

(72) Inventors: PAUL EMMANUEL LEHMANN, West Chester, PA (US); CARL JAMES STARKEY, II, Narberth, PA (US)

(21) Appl. No.: 18/298,938

(22) Filed: Apr. 11, 2023

Related U.S. Application Data
(60) Provisional application No. 63/329,767, filed on Apr. 11, 2022.

(51) Int. Cl. A23L 5/00; A23L 27/00; B05B 11/00

(52) U.S. Cl. CPC A23L 5/55; A23L 27/72; B05B 11/0056; G01F 19/00

(57) ABSTRACT

Methods and systems for making wet condiments are provided. In one example, a method for making a plurality of wet condiments of different types comprises: selecting a packet containing a dry rehydratable condiment for mixture into a container, the packet being selected from among a plurality of different packets corresponding to different types of dry rehydratable condiments having different intended condiment viscosity; adding a liquid into the container up to an indicia of the container, the indicia corresponding to a pre-determined quantity of the liquid for the selected packet; transferring the dry rehydratable condiment of the selected packet into the container; enclosing the container; mixing the dry rehydratable condiment and the liquid to generate one of the wet condiments; and repeating the above steps to generate each of the plurality of wet condiments, wherein the plurality of wet condiments have different viscosity among each other.

### CROSS-REFERENCE TO RELATED APPLICATIONS

The present application claims priority from U.S. Provisional Patent Application No. 63/329,767, filed on Apr. 11, 2022, the disclosure of which is hereby incorporated by reference in its entirety.

### INTRODUCTION

Consumers buy liquid or wet condiments from commercial sources like restaurants, supermarket, or grocery stores. Many of the commercial wet condiments are packaged in bottled containers in relatively large quantity. Often, these bottled condiments are discarded after a single or light use, which causes a significant waste of food and packaging materials, and generates non-reusable waste. Although methods and recipes for home-made condiments or sauces are available, many of them involve complex formulas or tedious procedures, and do not provide good consistency for the condiments. Therefore, there is a need for efficient, low-cost, and environmental-friendly methods and systems for repeatably and reliably making and customizing wet condiments.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

In some embodiments, a method for making a fresh and ready-to-use wet condiment comprises: selecting a packet containing a dry rehydratable condiment for mixture into a container, the packet being selected from among a plurality of different packets corresponding to different types of dry rehydratable condiments having different intended condiment viscosity; adding a liquid into the container up to an indicia of the container, the indicia corresponding to a pre-determined quantity of the liquid for the selected packet; transferring the dry rehydratable condiment of the selected packet into the container; enclosing the container; and mixing the dry rehydratable condiment and the liquid to generate the wet condiment.

In some embodiments, a method for making a plurality of wet condiments of different types comprises: selecting a packet containing a dry rehydratable condiment for mixture into a container, the packet being selected from among a plurality of different packets corresponding to different types of dry rehydratable condiments having different intended condiment viscosity; adding a liquid into the container up to an indicia of the container, the indicia corresponding to a pre-determined quantity of the liquid for the selected packet; transferring the dry rehydratable condiment of the selected packet into the container; enclosing the container; mixing the dry rehydratable condiment and the liquid to generate one of the wet condiments; and repeating the above steps to generate each of the plurality of wet condiments, wherein the plurality of wet condiments have different viscosity among each other.

In some embodiments, a kit for making a fresh and ready-to-use wet condiment comprises: at least one packet containing a dry rehydratable condiment; at least one reusable container, each container having at least one indicia corresponding to a pre-determined quantity of a liquid for making the wet condiment; and an instruction providing a method for using the kit to make the wet condiment, wherein the method comprises: transferring the dry rehydratable condiment from a packet containing the dry rehydratable condiment into a container; adding the liquid into the container up to the indicia of the container; and mixing the dry rehydratable condiment and the liquid to generate the wet condiment.

In some embodiments, a kit for making a plurality of fresh and ready-to-use wet condiments comprises: a plurality of packets, each packet containing a dry rehydratable condiment corresponding to a wet condiment to be made; at least one reusable container, each container having at least one indicia corresponding to a pre-determined quantity of a liquid for making a wet condiment; and an instruction providing, wherein the instruction provides a method for using the kit to make the plurality of wet condiments, wherein the method comprises: selecting a packet from among a plurality of different packets corresponding to different types of dry rehydratable condiments having different intended condiment viscosity; transferring the dry rehydratable condiment from the selected packet containing the dry rehydratable condiment into a container; adding the liquid into the container up to a selected indicia of the container, the selected indicia corresponding to the pre-determined quantity of the liquid that corresponds to the dry rehydratable condiment of the selected packet; and enclosing the container and shaking the container to generate the wet condiment for the selected packet.

The details of one or more techniques are set forth in the accompanying drawings and the description below. Other features, objects, and advantages of these techniques will be apparent from the description, drawings, and claims.

### BRIEF DESCRIPTION OF THE DRAWINGS

FIG. 1 illustrates a schematic view of one example system for condiment rehydration.

FIG. 2A illustrates a schematic view of one variation the device 200 according to the present disclosure.

FIG. 2B illustrates a schematic view of another variation of the device 200 according to the present disclosure.

FIG. 2C illustrates a schematic view of yet another variation of the device 200 according to the present disclosure.

FIG. 3 illustrates a block diagram of one example method for making a wet condiment, according to the various embodiments of the present disclosure.

FIG. 4 illustrates a block diagram of one example method for making a plurality of wet condiments, according to the various embodiments of the present disclosure.

Before one or more embodiments of the present teachings are described in detail, one skilled in the art will appreciate that the present teachings are not limited in their application to the details of construction, the arrangements of components, and the arrangement of steps set forth in the following detailed description or illustrated in the drawings. Also, it is to be understood that the terminology used herein is for the purpose of description and should not be regarded as limiting.

### DETAILED DESCRIPTION

### Definition or Interpretation of Selected Terms

For the purposes of interpreting this disclosure, the following definitions will apply and whenever appropriate, terms used in the singular will also include the plural and vice versa. The definitions set forth below shall supersede any conflicting definitions in any documents incorporated herein by reference.

As used herein, the singular forms “a,” “an,” and “the,” include both singular and plural referents unless the context clearly dictates otherwise.

The terms “comprising,” “comprises,” and “comprised of” as used herein are synonymous with “including,” “includes,” or “containing,” “contains,” and are inclusive or open-ended and do not exclude additional, non-recited members, elements or method steps. It will be appreciated that the terms “comprising,” “comprises,” and “comprised of” as used herein comprise the terms “consisting of,” “consists,” and “consists of.”

The recitation of numerical ranges by endpoints includes all numbers and fractions subsumed within the respective ranges, as well as the recited endpoints.

The term “about” or “approximately” as used herein when referring to a measurable value such as a parameter, an amount, a temporal duration, and the like, is meant to encompass variations of ±20% or less, preferably ±10% or less, more preferably ±5% or less, and still more preferably ±1% or less of and from the specified value, insofar such variations are appropriate to perform in the present disclosure. It is to be understood that the value to which the modifier “about” or “approximately” refers is itself also specifically, and preferably, disclosed.

Whereas the terms “one or more” or “at least one”, such as one or more or at least one member(s) of a group of members, is clear per se, by means of further exemplification, the term encompasses inter alia a reference to any one of said members, or to any two or more of said members, such as, e.g., any ≥3, ≥4, ≥5, ≥6, or ≥7, etc. of said members, and up to all said members.

As used herein, “weight percent,” “wt %, “percent by weight,” “% by weight,” and variations thereof refer to the concentration of a substance as the weight of that substance divided by the total weight of the composition and multiplied by 100. It is understood that, as used here, “percent,” “%,” and the like are intended to be synonymous with “weight percent,” “wt %, etc.

As used herein, “oz” represents ounce, one ounce equals to about 28.3 gram; “cup” is used as a weight unit, one cup equals to about 8 oz; “centipoise” or “cPs” or “cP” is used as a viscosity unit, and 1 cP=10⁻³ Pa·s=1 mPa·s.

Unless otherwise defined, all terms used in the present disclosure, including technical and scientific terms, have the meaning as commonly understood by one of ordinary skill in the art to which this disclosure belongs. By means of further guidance, term definitions are included to better appreciate the teaching of the present disclosure.

In the following passages, different aspects of the present disclosure are defined in more detail. Each aspect so defined may be combined with any other aspect or aspects unless clearly indicated to the contrary.

### System or Kit for Making Wet Condiment

In some aspects, the present disclosure is related to a system for making a wet condiment, various components of the system either each alone or in any combination, and various wet condiments made using the system.

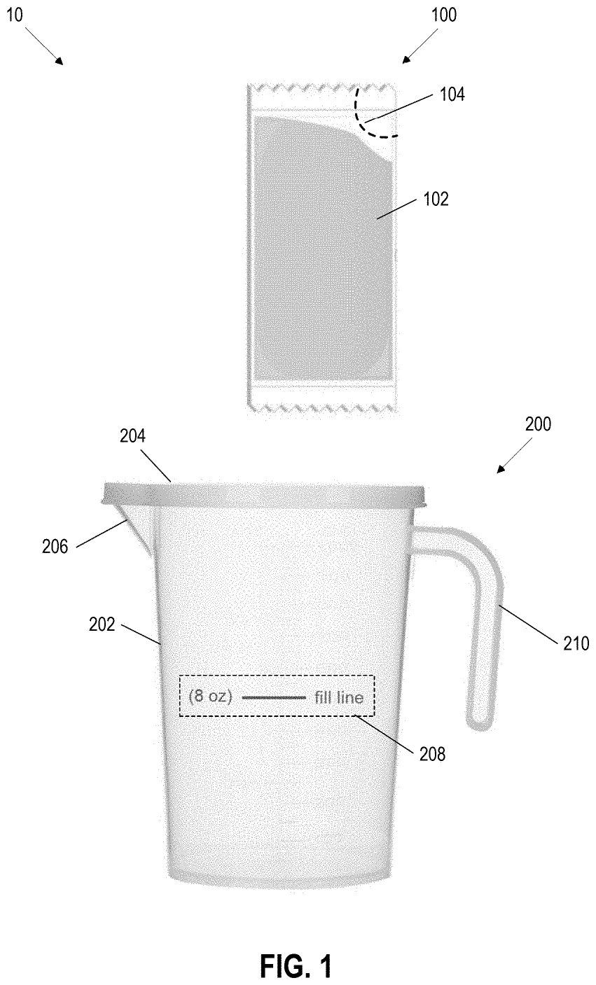

FIG. 1 illustrates a schematic view of one example system 10. The system 10 is generally used for making one or more fresh, ready-to-serve, or ready-to-use wet condiments. The system 10 may be a kit comprising one or more constituents of the system 10. The system 10 may be used by any consumer, including but not limited to home makers, chefs, restaurant workers, food suppliers, etc., for personal or commercial uses.

In the illustrated example, the system 10 includes at least one packet 100 containing a dry rehydratable condiment 102 therein. The packet 100 may be a one-time or disposable package or pouch that is sealed. The packet 100 or a majority thereof may be made of plastic, paper, composite, or other packaging materials commonly used in the food industry. Preferably, the packet 100 is made of a recyclable or degradable or biodegradable material. The packet 100 may be in various sizes, shapes, and colors. For example, the packet 100 may contain from about 0.1 oz to about 16 oz of the dry rehydratable condiment 102. Preferably, the packet 100 has a printed label on a surface of the packet indicating the type, quantity, nutrient profile, regulatory information of the dry rehydratable condiment 102 contained therein.

The dry rehydratable condiment 102 may be in a form of a solid or a dried powder. The sealed packet 100 may include an opening element 104 that allows users to create an opening and transfer the dry rehydratable condiment 102 out from the packet 100 through the created opening. The opening element 104 may be a pre-cut or a tear perforation that allows the users to easily initiate tearing when use.

The dry rehydratable condiment 102 includes a mixture of different ingredients, non-limiting examples of which include spices or seasonings (e.g., salt, pepper, garlic, mustard seed, onion, paprika, turmeric, and combinations thereof); fruits, vegetables, or their products (e.g., tomatoes or tomato-based products (paste, puree), fruit juices, fruit juice peels, and combinations thereof); oils or oil emulsions, particularly vegetable oils; thickeners (e.g., xanthan gum, food starch, other hydrocolloids, and combinations thereof); and emulsifying agents (e.g., egg yolk solids, protein, gum arabic, carob bean gum, guar gum, gum karaya, gum tragacanth, carageenan, pectin, propylene glycol esters of alginic acid, sodium carboxymethyl-cellulose, polysorbates, and combinations thereof).

The dry rehydratable condiment 102 may include other solid components such as any edible solid particulate food product which withstands a liquid and remains in particulate form when mixed with a liquid or in the formed wet condiment. Exemplary base solid components include but are not limited to solid particulate cheeses, such as Parmesan cheese, spice powders, such as ground white or black pepper, and other particulate solid food products, such as corn meal, which is optionally degerminated, or any other commercially available dry powder food or food product such as powdered milk, powdered fruit drink, powdered tea and coffee products, ground cereals, bread or bread crumbs, and flours. The dry rehydratable condiment 102 may have an average particle size of from about 0.1 millimeter to about 0.5 millimeter.

The dry rehydratable condiment 102 may optionally include an effective amount of a colorant and/or dye as desired or needed to achieve specific color effects of the corresponding wet condiment. Such colorant and dye may be synthetic or of natural origin, are well known to those in the art of edible products.

Optionally, the dry rehydratable condiment 102 may include other known food ingredients in an effective amount, including but not limited to antioxidants, preservatives, viscosity modifiers such as thickeners, nutritional supplements such as vitamins and/or minerals, and the like may be added either individually or in any desired combination to the solid condiments of the invention. The dry rehydratable condiment 102 may also include an effective amount of an anti-caking additives, in addition to any such additives which may already be present in the base solid. All of these optional components materials may have their typical amounts for usual purpose. These food ingredients may be added to the dry rehydratable condiment 102 while it is being formed.

One particular example of the dry rehydratable condiment 102 is a Ketchup-type dry rehydratable condiment intended to make a Ketchup-type wet condiment or sauce, wherein the Ketchup-type dry rehydratable condiment comprises: from about 35 wt % to about 40 wt % of brown sugar; from about 25 wt % to about 30 wt % of tomato powder; from about 10 wt % to about 15 wt % of vinegar powder; from about 25 wt % to about 30 wt % of tomato powder; from about 2 to about 8 wt % of salt; from about 2 wt % to about 5 wt % of a modified food starch; from about 2 wt % to about 5 wt % of a antimicrobial agent (sodium diacetate); from about 2 wt % to about 5 wt % of garlic powder; from about 0 to about 2 wt % of a hydrolyzed vegetable protein; from about 0 to about 2 wt % of a natural flavor; and from about 0 to about 2 wt % of an anticaking agent such as tricalcium phosphate, wherein the wt % is calculated based on the total weight of the dry rehydratable condiment.

Another particular example of the dry rehydratable condiment 102 is a BBQ-type dry rehydratable condiment intended to make a BBQ-type wet condiment or sauce, wherein the BBQ-type dry rehydratable condiment comprises: from about 35 wt % to about 40 wt % of brown sugar; from about 25 wt % to about 30 wt % of vinegar powder; from about 10 wt % to about 15 wt % of tomato powder; from about 5 wt % to about 10 wt % of a modified food starch; from about 3 to about 5 wt % of salt; from about 2 wt % to about 5 wt % of black malt powder; from about 0 to about 2 wt % of honey powder; from about 0 wt % to about 2 wt % of onion powder; from about 0 wt % to about 2 wt % of garlic powder; from about 0 to about 2 wt % of one or more spices; from about 0 to about 2 wt % of smoked paprika; from about 0 to about 2 wt % of a antimicrobial agent (sodium diacetate); from about 0 to about 2 wt % of a hydrolyzed vegetable protein; from about 0 to about 2 wt % of a natural smoke flavor; and from about 0 to about 2 wt % of an anticaking agent (tricalcium phosphate), wherein the wt % is calculated based on the total weight of the dry rehydratable condiment.

Yet another particular example of the dry rehydratable condiment 102 is a Chesapeake style hot dry rehydratable condiment intended to make a Chesapeake style hot sauce or wet condiment, wherein the Chesapeake style hot dry rehydratable condiment comprises: from about 25 wt % to about 35 wt % of cayenne pepper sauce; from about 15 wt % to about 25 wt % of sugar; from about 5 wt % to about 10 wt % of one or more spices; from about 5 wt % to about 10 wt % of a modified food starch; from about 5 wt % to about 10 wt % of molasses powder; from about 5 wt % to about 8 wt % of salt; from about 4 wt % to about 8 wt % of garlic powder; from about 4 wt % to about 8 wt % of vinegar powder; from about 2 wt % to about 5 wt % of honey powder; from about 0 to about 2 wt % of paprika; from about 0 to about 2 wt % of jalapeño pepper; from about 0 to about 2 wt % of a coloring agent (paprika extractive); from about 0 to about 2 wt % of a natural flavor; from about 0 to about 2 wt % of a thickener (xanthan gum); from about 0 to about 2 wt % of citric acid; and from about 0 to about 2 wt % of an anticaking agent (tricalcium phosphate), wherein the wt % is calculated based on the total weight of the dry rehydratable condiment.

Additional non-limiting examples of the wet condiments derived from the dry rehydratable condiment 102 include catsup; mustard; butter; chili sauce; chutney; cocktail sauce; curry; dips; fish sauce; horseradish; hot sauce; jellies, jams, marmalades, or preserves; mayonnaise; peanut butter; relish; remoulade; salad dressings (e.g., oil and vinegar, Caesar, French, ranch, bleu cheese, Russian, Thousand Island, Italian, and balsamic vinaigrette), salsa; sauerkraut; soy sauce; steak sauce; syrups; tartar sauce; and Worcestershire sauce.

The dry rehydratable condiment 102 could be rehydrated or reconstituted in a liquid when mixing with the liquid to form the corresponding wet condiment. The liquid may be water or a solution that imparts a distinctive or accenting color, flavor and/or aroma to the intended wet condiment. As used herein, the term “liquid” includes any edible substance, or mixtures thereof, which takes the physical form of a liquid, i.e., is able to flow, at about 25° C. temperature and about 760 mm Hg pressure. Such liquids may be of relatively low viscosity, such as wine, beer or coffee, or relatively viscous, such as fruit pressings, edible oils or syrups. Additionally, the term “liquid” as used herein includes solutions and flowable liquid-like Substances which may contain a plurality of phases, such as mixtures, suspensions, emulsions, microemulsions, dispersions, pastes and slurries. Non-limiting examples of the liquid used herein include water, alcoholic beverages, coffee, tea, chocolate liquid, fruit liquid, berry liquid, vegetable liquid, spice liquid, herb liquid, wine, beer, hard liquor, liqueur, champagne, orange juice, lemon juice, cranberry juice, juniper berry liquid, strawberry liquid almond liquid, liquid vanilla, cinnamon liquid, saffron liquid, red pepper liquid, mint liquid, basil liquid, milk, plant-based milk, or any combinations thereof. In one particular embodiment, the liquid is water.

The wet condiment derived from the dry rehydratable condiment 102 may have a viscosity from about 8,000 cp to 180,000 cp, or from about 25,000 cp to about 140,000 cp, or from about 50,000 cp to about 100,000 cp, as measured by a common viscometer under normal conditions, e.g., with a Brookfield type viscometer at a temperature of 5° C. with spindle S93 and a speed of 10 rpm.

The wet condiment may have a solid content from about 5 wt % to about 95 wt %, or from about 10 wt % to about 90 wt %, or from about 20 wt % to about 80 wt %, or from about 30 wt % to about 70 wt %, or from about 40 wt % to about 60 wt %, based on the total weight of the wet condiment.

The quantity of liquid needed for rehydrating a particular type of the dry rehydratable condiment 102 is pre-determined based on the type, intended viscosity, desired mouth feel, thickness, and texture of the wet condiment. The quantity ratio of the liquid to the dry rehydratable condiment 102 ranges from about 1:10 to about 10:1, from about 1:5 to about 5:1, or from about 1:2 to about 2:1.

Now referring back to FIG. 1, the system 10 may optionally include a device 200. The device 200 is configured to accommodate the dry rehydratable condiment 102 and a liquid, to precisely measure the quantity of the liquid for rehydrating the dry rehydratable condiment 102, and to form and contain the intended wet condiment.

The device 200 may be in a form of a container having a main body 202, a sealing member 204, optionally a guiding member 206, at least one visible measure or indicia 208, and optionally a handling member 210. The device 200 or a majority thereof may be made of food-safe material such as stainless steel, glass, plastic, or coated paper. In some embodiments, the device 200 or a majority thereof is made of recyclable or reusable materials such as degradable plastic having a light weight.

The main body 202 may be of various shapes such as bottle-like or box-like shape. The main body 202 is configured to receive and contain the dry rehydratable condiment 102 transferred from the packet 100 as well as a liquid from a liquid source. The sealing member 204 may be either permanently or removably attached to a part of the main body 202. The sealing member 204 is configured to seal the device 200 when in use to prevent the content therein from leaking out of the device 200. For example, the sealing member 204 may be a lid or cap that matches an aperture of the device 200 to form a closure. The guiding member 206 may be in a form of a pour spout that allows the flowable content (e.g., the wet condiment) in the device 200 to flow out through it at a consistent and controllable rate. The handling member 210 allows users to hold the device 200 by one hand during operation. Preferably, the device 200 or any component thereof does not have a sharp part of edge where mixing of the dry rehydratable condiment 102 and the liquid could get stuck. In other examples, the guiding member 206 and the handling member are optional, and could be excluded entirely.

The device 200 includes at least one indicia 208 which identifies a liquid level within an interior volume of the device 200 corresponding to a quantity of water needed for rehydrating the dry rehydratable condiment 102 transferred from the packet 100. The indicia 208 is visible to a user (e.g., visible on an interior surface of the device 200, or visible through the device from external to the device, if the device is transparent or translucent) and contains sufficient information to guide the users to add the desired quantity of liquid to the device 200. The indicia may be bonded to, or printed or embossed on an exterior surface of the main body 202. For example, the indicia 208 may include a fill line combined with labels or words indicative of the pre-determined quantity of the liquid (e.g., 4 oz or 30 mL or 1 cup) needed for the rehydrating the corresponding dry rehydratable condiment 102. It is noted that the quantity of the liquid indicated by the indicia 208 is pre-determined based on the quantity of the dry rehydratable condiment 102. For example, the packet 100 may contain about 1.87 oz of the dry rehydratable condiment 102 which will need about ⅓ cup (or about 2.7 oz) of water to form the wet condiment in the device 200, and the indicia 208 may include a water fill line corresponding to about ⅓ cup of water and/or information indicative of the quantity of water for making the intended wet condiment.

In some embodiments, the device 200 has only one indicia 208 corresponding to a uniform quantity of liquid for different types of dry rehydratable condiments 102 from a plurality of different packets 100. In such instances, different types of dry rehydratable condiments 102 may have differing amounts of dry ingredients, and result in different thickness, or viscosity. That is, use of a same quantity of liquid (e.g., water) allows users to make different wet condiments of different type and/or of different viscosity from different dry rehydratable condiments in a very quick and efficient way, since users measure the same amount of liquid for all different condiments, and the different amounts of dry ingredients included in a packet 100 may differ for different dry rehydratable condiments 102.

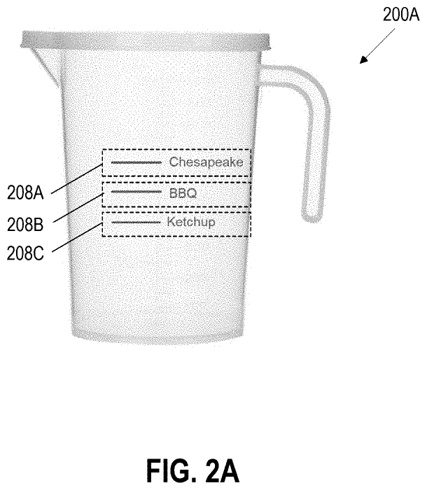

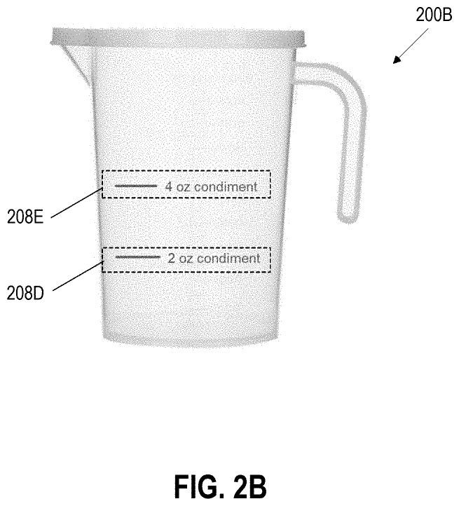

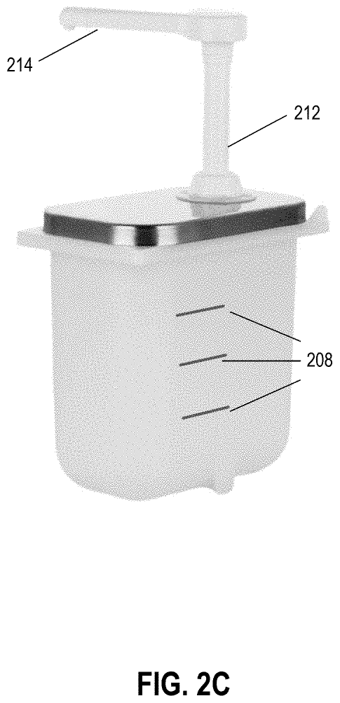

A variation example of the device 200 is illustrated in FIG. 2A. In the illustrated example, the device 200A includes a plurality of indicia 208, each indicia corresponding to a pre-determined quantity of liquid needed for a particular type of dry rehydratable condiment 102 from among a plurality of the packets 100. For example, indicia 208A corresponds to a Ketchup-type condiment; indicia 208B corresponds to a BBQ-type condiment; and indicia 208C corresponds to a Chesapeake style hot sauce. This would allow the users to efficiently make different types of wet condiments without confusion.

Another variation example of the device 200 is illustrated in FIG. 2B. In the illustrated example, the device 200B includes a plurality of indicia 208, each indicia corresponding to a pre-determined quantity of liquid needed for a target quantity of wet condiment from the same rehydratable condiment 102. For example, indicia 208D corresponds to the quantity needed for making about 2 oz of the intended wet condiment (e.g., requiring one packet 100); and indica 208E corresponds to the quantity needed for making about 4 oz of the same wet condiment (e.g., requiring two packets 100). This would allow the users to customize and precisely control the quantity of the wet condiments need for service, without losing the consistency thereof.

Yet another variation example of the device 200 is illustrated in FIG. 2C. In the illustrated example, the device 200C is a dispenser-type container common in the food industry, The device 200C additionally includes a dispensing pump 212 coupled with a dispensing tube 214 configured to dispense the wet condiment out of the device 200C and deliver the wet condiment to a desired place.

In some embodiments, the system 10 can be constructed as a kit. The kit may further include a container or package (not shown) that encloses various components and keep them separate therein. The kit may be provided as an end product or merchandise readily for sale. In some embodiments, he kit includes at least one packet 100 and at least one device 200.

In some embodiments, the kit may include a plurality of packets 100. In such cases, each packet 100 may be the same in size or content, e.g., containing the same dry rehydratable condiment in same quantity. Alternatively the plurality of packets 100 may be different in packet size and/or type of the dry rehydratable condiment. In particular embodiments, the plurality of packets 100 comprise at least two of: a packet containing a dry rehydratable condiment for making a Ketchup-type sauce; a packet containing a dry rehydratable condiment for making a BBQ-type sauce; and a packet containing a dry rehydratable condiment for making a Chesapeake style hot sauce, according to the present disclosure.

In some embodiments, the kit may include a plurality of the devices 200, each device including an indicia 208 corresponding to a particular quantity of liquid needed for making a target quantity of the wet condiment, or corresponding to a particular type of the dry rehydratable condiment, or corresponding to both.

In some embodiments, the kit may include a plurality of packets 100 and a plurality of the devices 200.

In some embodiments, the kit may optionally include other commonly used kitchen wares or utensils (not shown), including but not limited to measuring cup, mixing stick, additional containers, dish plates, paper towels, etc.

The kit may further include an instruction (not shown) providing information regarding the ingredients of the dry rehydratable condiment and the methods of using the kit or making wet condiments. The instruction may be provided as a separate printed sheet. Alternatively, the instruction may be printed on an exterior surface of the packet 100 or the device 200, or both. The instruction may also contain virtual information easily identifiable and accessible on Internet. The instruction may provide nutrient profile, packet size, serving size, regulatory information, etc., of the dry rehydratable condiment 102 for each packet. The instruction may also provide the correlation between the pre-determined quantity of liquid and each particular type of the dry rehydratable condiment 102, the correlation between the pre-determined quantity of liquid and the target quantity of wet condiment, or both. The method for making wet condiments provided in the instruction is described infra.

### Method for Making Wet Condiment

In some aspects, the present disclosure provides a method for making a fresh and ready-to-use wet condiment, the method comprising: combining a dry rehydratable condiment with a pre-determined quantity of a liquid, wherein the quantity of the liquid is pre-determined based on the type of the dry rehydratable. Various aspects of the dry rehydratable condiment, the liquid, and the resultant wet condiment are described supra and will not be repeated unless otherwise indicated.

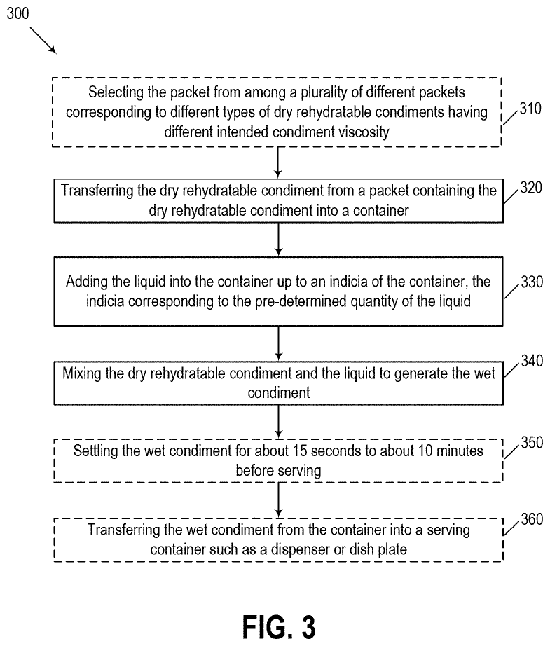

FIG. 3 illustrates a flow diagram of one example method 300 for making the wet condiment. In the illustrated example, the method 300 includes operations 320, 330, 340, and optionally operations 310, 350, and 360. The method may be implemented by the system 10 or selected components thereof as described supra.

In the illustrated example, operation 320 includes transferring a dry rehydratable condiment 102 from a packet 100 containing the dry rehydratable condiment 102 into a container. The container may be a measuring container having an indicia corresponding the quantity of liquid needed to rehydrate the dry rehydratable condiment 102. For example, the container may be the device 200 described herein. An advantage of using such a device includes user convenience, since the user does not need to separately measure a liquid to be used in making the wet condiment, but simply should fill the container to the indicia prior to adding the dry rehydratable condiment 102. Alternatively, the container may be any kitchen wares (e.g., glass jar) that have an indicia for users to measure and fill up the container with the desired quantity of the liquid. Operation 330 includes adding the liquid into the container up to the indicia of the container, the indicia corresponding to the pre-determined quantity of the liquid. Operation 340 includes mixing the dry rehydratable condiment and the liquid to generate the wet condiment. Operation 320 and 330 may be performed sequentially or simultaneously. In some embodiments, operation 330 is performed before operation 320. Operation 340 may further include enclosing the container and shaking the container to mix the dry rehydratable condiment liquid in the pre-determined quantity to generate the wet condiment. The container may be shaken for about 15 seconds to about 2 minutes, continuously or intermittently. Operation 340 may be repeated until the wet condiment is homogeneously mixed or is ready to use.

The optional operation 310 includes selecting the packet from among a plurality of different packets corresponding to different types of dry rehydratable condiments having different intended condiment viscosity. The optional operation 350 includes settling the wet condiment for about 15 seconds to about 10 minutes before serving. The optional operation 360 includes transferring the wet condiment out from the container. The wet condiment may be transferred into a serving ware such as a dispenser or dish plate. In some embodiments, the container used in the method 300 is a pump disperser such as the device 200C described herein, and operation 360 is no longer needed.

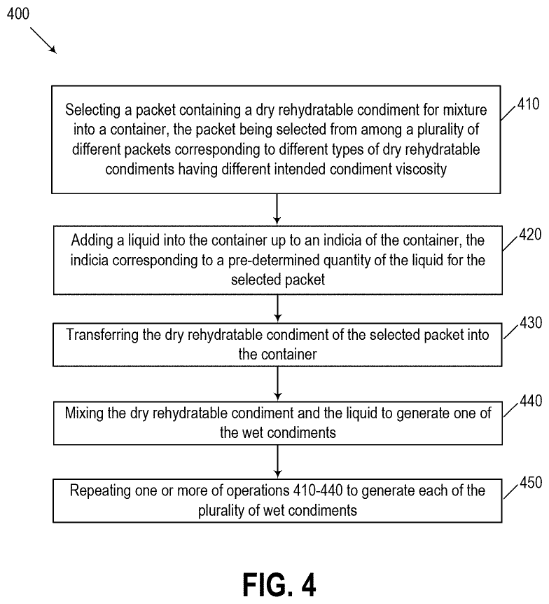

FIG. 4 illustrates a flow diagram of another example method 400 for making a plurality of wet condiments. In the illustrated example, the method 400 includes operations 410, 420, 430, 440, and 450. Operation 410 includes selecting a packet containing a dry rehydratable condiment for mixture into a container, the packet being selected from among a plurality of different packets corresponding to different types of dry rehydratable condiments having different intended condiment viscosity. The plurality of different packets may be provided in the system 10 or kit described herein.

Operation 420 includes adding a liquid into the container up to an indicia of the container, the indicia corresponding to a pre-determined quantity of the liquid for the selected packet. Operation 430 includes transferring the dry rehydratable condiment of the selected packet into the container. Operation 440 includes mixing the dry rehydratable condiment and the liquid to generate one of the wet condiments corresponding to the selected packet. Operation 450 includes repeating one or more of operations 410-440 to generate each of the plurality of wet condiments. The method 400 may further includes the similar optional operations of the method 300 described herein.

In some embodiments, the present disclosure is related to the any condiment derived from the dry rehydratable condiment or made by the methods described herein.

The present system and method can be performed anywhere when needed, including but not limited to home, party event, stadium, sport event, restaurant, on travel, on camping, etc. Wet condiments of various quantity and types could be made on demand.

The following examples illustrate preferred, but non-limiting embodiments of the present disclosure.

### EXAMPLES

### Example 1—Ketchup Sauce

An example of the dry rehydratable condiment formula is provided in Table 1. The dry Ketchup Sauce is an orange, tan, and off-white powder packaged in a packet at various sizes. The wet Ketchup sauce could be made by mixing about 1.87 oz of the Ketchup Sauce with about ⅓ cup (or about 2.7 oz) of water. A sealable and dispensable container having an indicia corresponding to the pre-determined quantity of water or the predetermined ratio of water to the dry Ketchup Sauce may be used for measuring water and mixing the wet Ketchup Sauce.

TABLE 1
Formula of the dry Ketchup Sauce.

| Ingredient | Weight % |
|---|---|
| BROWN SUGAR | 35-40% |
| TOMATO POWDER | 25-30% |
| VINEGAR POWDER | 10-15% |
| SALT | 5.5% |
| MODIFIED FOOD STARCH | 2-5% |
| SODIUM DIACETATE | 2-5% |
| ONION POWDER | 2-5% |
| GARLIC POWDER | 2-5% |
| HYDROLYZED CORN PROTEIN | <2% |
| NATURAL FLAVOR | <2% |
| CALCIUM STEARATE (PREVENTS CAKING) | <2% |

### Example 2—Barbeque (BBQ) Sauce

Another example of the dry rehydratable condiment formula is provided in Table 2. The dry BBQ Sauce is a brown and tan powder packaged in a packet at various sizes. The wet BBQ sauce could be made by mixing about 2.04 oz of the BBQ Sauce with about ⅓ cup (or about 2.7 oz) of water. A sealable and dispensable container having an indicia corresponding to the pre-determined quantity of water or the predetermined ratio of water to the dry BBQ Sauce may be used for measuring water and mixing the wet BBQ sauce.

TABLE 2
Formula of the dry BBQ Sauce.

| Ingredient | Weight % |
|---|---|
| BROWN SUGAR | 35-40% |
| VINEGAR POWDER | 20-25% |
| TOMATO POWDER | 10-15% |
| MODIFIED FOOD STARCH | 5-10% |
| SALT | 3-5% |
| BLACK MALT POWDER | 2-5% |
| HONEY POWDER | <2% |
| SPICES (including Mustard seed, Red and Black | <2% |
| Pepper, and Cumin) | |
| ONION POWDER | <2% |
| GARLIC POWDER | <2% |
| SMOKED PAPPRIKA | <2% |
| HYDROLYZED CORN PROTEIN | <2% |
| NATURAL SMOKE FLAVOR | <2% |
| NATURAL FLAVORS | <2% |
| TRICALCIUM PHOSPHATE (PREVENTS | <2% |
| CAKING) | |

### Example 3—Chesapeake Style Hot Sauce

Another example of the dry rehydratable condiment formula is provided in Table 3. The dry Chesapeake Style Hot Sauce is an orange powder with visible spice particles packaged in a packet at various sizes. The wet Chesapeake Style Hot Sauce could be made by mixing about 0.89 oz of the dry Chesapeake Style Hot Sauce with about ⅓ cup (or about 2.7 oz) of water. A sealable and dispensable container having an indicia corresponding to the pre-determined quantity of water or the predetermined ratio of water to the dry Chesapeake Style Hot Sauce may be used for measuring water and mixing the wet Chesapeake Style Hot Sauce.

TABLE 3
Formula of the dry Chesapeake Style Hot Sauce.

| Ingredient | Weight % |
|---|---|
| CAYENNE PEPPER SAUCE | 25-30% |
| SUGAR | 15-20% |
| SPICES | 5-10% |
| MODIFIED FOOD STARCH | 5-10% |
| MOLASSES POWDER | 5-10% |
| SALT | 5-8% |
| GARLIC POWDER | 4-8% |
| VINEGAR POWDER | 4-8% |
| HONEY POWDER | 2-5% |
| PAPRIKA | <2% |
| JALAPENO PEPPER | <2% |
| PAPRIKA EXTRACTIVE (COLOR) | <2% |
| NATURAL FLAVORS (contains milk) | <2% |
| XANTHAN GUM | <2% |
| CITRIC ACID | <2% |
| CALCIUM STEARATE (ANTI-CAKING) | <2% |

Although various embodiments and examples are described herein, those of ordinary skill in the art will understand that many modifications may be made thereto within the scope of the present disclosure. Accordingly, it is not intended that the scope of the disclosure in any way be limited by the examples provided.

What is claimed is:

1. A method for making a fresh and ready-to-use wet condiment, the method comprising:
combining a dry rehydratable condiment with a pre-determined quantity of a liquid,
wherein the quantity of the liquid is pre-determined based on the type of the dry rehydratable condiment.

2. The method of claim 1, further comprising:
transferring the dry rehydratable condiment from a packet containing the dry rehydratable condiment into a container;
adding the liquid into the container up to an indicia of the container, the indicia corresponding to the pre-determined quantity of the liquid; and
mixing the dry rehydratable condiment and the liquid to generate the wet condiment.

3. The method of claim 2, wherein,
the liquid is added to the container first; and
the dry rehydratable condiment is added to the liquid in the container.

4. The method of claim 2, further comprising:
selecting the packet from among a plurality of different packets corresponding to different types of dry rehydratable condiments having different intended condiment viscosity.

5. The method of claim 2, further comprising:
enclosing the container; and
shaking the container to generate the wet condiment.

6. The method of claim 5, wherein the enclosed container is shaken for about 15 seconds to about 2 minutes, continuously or intermittently.

7. The method of claim 2, further comprising:
settling the wet condiment for about 15 seconds to about 10 minutes before serving.

8. The method of claim 2, wherein the container has a plurality of indicia, each indicia corresponding to a quantity of liquid pre-determined for reconstituting a specific type or a specific quantity of a dry rehydratable condiment.

9. The method of claim 2, wherein the container is reusable or recyclable.

10. The method of claim 2, wherein the container is a pump container comprising a dispensing pump configured to dispense the wet condiment out of the pump container.

11. The method of claim 2, further comprising:
transferring the wet condiment from the container into a serving container such as a dispenser or dish plate.

12. The method of claim 1, wherein the liquid is water.

13. The method of claim 1, wherein the wet condiment is a Ketchup-type sauce, and wherein the dry rehydratable condiment comprises:
from about 35 wt % to about 40 wt % of brown sugar;
from about 25 wt % to about 30 wt % of tomato powder;
from about 10 wt % to about 15 wt % of vinegar powder;
from about 25 wt % to about 30 wt % of tomato powder;
from about 2 to about 8 wt % of salt;
from about 2 wt % to about 5 wt % of a modified food starch;
from about 2 wt % to about 5 wt % of an antimicrobial agent (sodium diacetate);
from about 2 wt % to about 5 wt % of garlic powder;
from about 0 to about 2 wt % of a hydrolyzed vegetable protein;
from about 0 to about 2 wt % of a natural flavor; and
from about 0 to about 2 wt % of an anticaking agent (tricalcium phosphate).

14. The method of claim 1, wherein the wet condiment is a BBQ-type sauce, and wherein the dry rehydratable condiment comprises:
from about 35 wt % to about 40 wt % of brown sugar;
from about 25 wt % to about 30 wt % of vinegar powder;
from about 10 wt % to about 15 wt % of tomato powder;
from about 5 wt % to about 10 wt % of a modified food starch;
from about 3 to about 5 wt % of salt;
from about 2 wt % to about 5 wt % of black malt powder;
from about 0 to about 2 wt % of honey powder;
from about 0 wt % to about 2 wt % of onion powder;
from about 0 wt % to about 2 wt % of garlic powder;
from about 0 to about 2 wt % of one or more spices;
from about 0 to about 2 wt % of smoked paprika;
from about 0 to about 2 wt % of an antimicrobial agent (sodium diacetate);
from about 0 to about 2 wt % of a hydrolyzed vegetable protein;
from about 0 to about 2 wt % of a natural smoke flavor; and
from about 0 to about 2 wt % of an anticaking agent (tricalcium phosphate).

15. The method of claim 1, wherein the wet condiment is a Chesapeake style hot sauce, and wherein the dry rehydratable condiment comprises:
from about 25 wt % to about 35 wt % of cayenne pepper sauce;
from about 15 wt % to about 25 wt % of sugar;
from about 5 wt % to about 10 wt % of one or more spices;
from about 5 wt % to about 10 wt % of a modified food starch;
from about 5 wt % to about 10 wt % of molasses powder;
from about 5 wt % to about 8 wt % of salt;
from about 4 wt % to about 8 wt % of garlic powder;
from about 4 wt % to about 8 wt % of vinegar powder;
from about 2 wt % to about 5 wt % of honey powder;
from about 0 to about 2 wt % of paprika;
from about 0 to about 2 wt % of jalapeño pepper;
from about 0 to about 2 wt % of a coloring agent (paprika extractive);
from about 0 to about 2 wt % of a natural flavor;
from about 0 to about 2 wt % of a thickener (xanthan gum);
from about 0 to about 2 wt % of citric acid; and
from about 0 to about 2 wt % of an anticaking agent (tricalcium phosphate).

16. The method of claim 1, wherein the wet condiment has a viscosity from about 8,000 cp to 180,000 cp, or from about 25,000 cp to about 140,000 cp, or from about 50,000 cp to about 100,000 cp, as measured with a Brookfield type viscometer at a temperature of 5° C. with spindle S93 and a speed of 10 rpm.

17. The method of claim 4, further comprising:
making a plurality of wet condiments corresponding to the plurality of different packets corresponding to different types of dry rehydratable condiments using the method of claim 1.

18. The method of claim 17, wherein the same quantity of the liquid corresponding to the indicia of the container is used to separately make each of the plurality of wet condiments.

19. The method of claim 18, wherein the plurality of the wet condiments have different viscosity among each other.

20. The method of claim 17, wherein the plurality of packets comprises at least two of:
a packet containing a dry rehydratable condiment for making a Ketchup-type sauce;
a packet containing a dry rehydratable condiment for making a BBQ-type sauce; and
a packet containing a dry rehydratable condiment for making a Chesapeake style hot sauce.

21. A method for making a fresh and ready-to-use wet condiment, the method comprising:
selecting a packet containing a dry rehydratable condiment for mixture into a container, the packet being selected from among a plurality of different packets corresponding to different types of dry rehydratable condiments having different intended condiment viscosity;
adding a liquid into the container up to an indicia of the container, the indicia corresponding to a pre-determined quantity of the liquid for the selected packet;
transferring the dry rehydratable condiment of the selected packet into the container;
enclosing the container; and
mixing the dry rehydratable condiment and the liquid to generate the wet condiment.

22. A method for making a plurality of wet condiments of different types, the method comprising:
selecting a packet containing a dry rehydratable condiment for mixture into a container, the packet being selected from among a plurality of different packets corresponding to different types of dry rehydratable condiments having different intended condiment viscosity;
adding a liquid into the container up to an indicia of the container, the indicia corresponding to a pre-determined quantity of the liquid for the selected packet;
transferring the dry rehydratable condiment of the selected packet into the container;
enclosing the container;
mixing the dry rehydratable condiment and the liquid to generate one of the wet condiments; and
repeating the above steps to generate each of the plurality of wet condiments,
wherein the plurality of wet condiments have different viscosity among each other.

23. The method of claim 22, further comprising:
reusing the container for making each of the plurality of the wet condiments,
wherein the same quantity of the liquid is used for the plurality of the wet condiments.

24. A kit for making a fresh and ready-to-use wet condiment, the kit comprising:
at least one packet containing a dry rehydratable condiment;
at least one reusable container, each container having at least one indicia corresponding to a pre-determined quantity of a liquid for making the wet condiment; and
an instruction providing a method for using the kit to make the wet condiment,
wherein the method comprises:
transferring the dry rehydratable condiment from a packet containing the dry rehydratable condiment into a container;
adding the liquid into the container up to the indicia of the container; and
mixing the dry rehydratable condiment and the liquid to generate the wet condiment.

25. The kit of claim 24, further comprising:
at least one reusable measuring cup configured to measure a quantity of liquid to be added to the container.

26. The kit of claim 24, further comprising: a serving container configured to receive the wet condiment transferred out from the container.

27. The kit of claim 24, further comprising: a serving container configured to receive the wet condiment transferred out from the container.

28. A kit for making a plurality of fresh and ready-to-use wet condiments, the kit comprising:
a plurality of packets, each packet containing a dry rehydratable condiment corresponding to a wet condiment to be made;
at least one reusable container, each container having at least one indicia corresponding to a pre-determined quantity of a liquid for making a wet condiment; and
an instruction providing: a method for using the kit to make the plurality of wet condiments, wherein the method comprises:
selecting a packet from among a plurality of different packets corresponding to different types of dry rehydratable condiments having different intended condiment viscosity;
transferring the dry rehydratable condiment from the selected packet containing the dry rehydratable condiment into a container;
adding the liquid into the container up to a selected indicia of the container, the selected indicia corresponding to the pre-determined quantity of the liquid that corresponds to the dry rehydratable condiment of the selected packet; and
enclosing the container and shaking the container to generate the wet condiment for the selected packet.

29. The kit of claim 28, comprising a plurality of the containers, each container configured to be used for making a particular type of wet condiment corresponding to one of the plurality of packets.
